(19) United States
(12) Patent Application Publication
(10) Pub. No.: US 2014/0098210 A1
(43) Pub. Date: Apr. 10, 2014

(54) APPARATUS AND METHOD

(71) Applicant: PROMPTCAM LIMITED, Bromsgrove (GB)

(72) Inventor: Peter Larter, Bromsgrove (GB)

(73) Assignee: Promtcam Limited, Bromsgrove (GB)

(21) Appl. No.: 14/122,845

(22) PCT Filed: May 31, 2012
(86) PCT No.: PCT/GB2012/051233

§ 371 Date: Nov. 27, 2013

(30) Foreign Application Priority Data
May 31, 2011 (GB) 1109105.5
Nov. 18, 2011 (GB) 1119980.9

(51) Int. Cl. H04N 5/222

(52) U.S. Cl. CPC H04N 5/2222
USPC 348/77

(57) ABSTRACT

In an aspect of the invention there is provided apparatus comprising: a plurality of image processing modules, each image processing module being one selected from amongst an image capture module and an image projection module, the apparatus comprising at least one image capture module and at least one image projection module; and a reflector member, the image projection module being arranged to project an image onto the reflector member for viewing by a user, the image capture module being arranged to capture an image of the user via the reflector member, at least one of the image processing modules being arranged to receive operational data from a source external to the module.

### FIELD OF THE INVENTION

The present invention relates to apparatus for aiding communication and a method thereof. In particular but not exclusively the invention relates to apparatus for aiding one-way or two-way communication between two or more persons.

### BACKGROUND

It is known to provide apparatus to assist a speaker when addressing an audience by displaying the speaker's script on a display screen readily viewable by the speaker.

GB2403371 discloses apparatus having a projector arranged to project an image of a speaker's script onto a transparent screen through which the speaker may view at least some members of the audience. The document discloses mounting the projector at the level of the floor on which the speaker is standing so as not to restrict the audience's view of the speaker. The projector is arranged to project substantially vertically upwards, the screen being tilted at an angle so as to reflect an image of the script from the projector to the speaker.

GB2403371 also discloses co-locating a camera with the projector in order to record the speaker's presentation. The camera is arranged to record a reflected image of the speaker provided by the transparent screen.

It is also known to provide apparatus for capturing video and audio data in respect of an event and broadcasting the event to a remote audience. Where multiple parties require video and audio data, the problem exists that it may be difficult or impossible to allow each of the parties to be present to capture the data, for example due to physical space constraints in respect of personnel and/or equipment.

It is an aim of embodiments of the present invention to at least partially mitigate one or more disadvantages of known apparatus.

### STATEMENT OF THE INVENTION

Embodiments of the invention may be understood by reference to the appended claims.

In one aspect of the invention for which protection is sought there is provided apparatus comprising: a plurality of image processing modules, each image processing module being one selected from amongst an image capture module and an image projection module, the apparatus comprising at least one image capture module and at least one image projection module; and a reflector member, the image projection module being arranged to project an image onto the reflector member for viewing by a user, the image capture module being arranged to capture an image of the user via the reflector member, at least one of the image processing modules being arranged to receive operational data from a source external to the module.

The apparatus may be operable as communications apparatus, for example as a prompting apparatus for a presenter.

By the term ‘via’ the reflector member is included transmission or reflection of light by the reflector member in order for the light to reach the image capture module.

The external source may comprise another one of said modules.

This feature has the advantage that operational data may be shared between modules such that if a setting of one module is adjusted, data in respect of the adjustment may be transmitted to another module.

Thus one module may be arranged to communicate with another module thereby to share operational data between the modules.

One of the modules may be a master module and another module may be a slave module, the slave module being arranged to receive operational data from the master module such that when an operational parameter of the master module is changed a corresponding change may be made to a corresponding operational parameter of the slave module.

This has the advantage that a setting of one image processing module may automatically be changed when the setting of another image processing module changes.

The master module may for example be a first image capture module or camera module or device, the slave module may be a second image capture module or camera module or device.

This feature is advantageous in that in some embodiments an operator need only send a control signal to the master module, and not to the master module and a slave module.

Once the operational data has been received by the master module, the master module may respond by making any required operational changes, for example changing an operational parameter thereof. A signal is also provided to the slave module causing the slave module to make a corresponding operational change.

It is to be understood that the signal to the slave module may be provided by the master module in direct response to the receipt of operational data by the master module, independently of whether the master module acts on the operational data received. The master module may for example make a change to one or more operational parameters thereof. Alternatively, the slave module may be arranged to respond only to changes in operational settings of the master module that actually take place. For example the slave module may respond to changes made to one or more operational settings of the master module. Thus if the master module does make a change to a prescribed one or more operational parameters thereof in response to receipt by the master module of operational data, the slave module may make a corresponding change to one or more of its own operational parameters.

The master module may be arranged to output operational data to the slave module when it is determined by the master module that the slave module should make a corresponding change to one or more operational parameters of the slave module. Alternatively or in addition the one or more slave modules may be arranged to take an initiative and query the master module, for example to determine whether a change to one or more operational parameters of the master module has been made. For example the slave module may query the master module to check whether a change to one or more operational parameters has taken place, and/or as to whether operational data has been received, regardless of whether action has been taken by the master module in response to receipt of the operational data. The slave module may for example be arranged periodically to query the master module. Alternatively or in addition the slave module may be arranged to query the master module when it is determined that operational data has been received by the master module.

In some embodiments, the master and one or more slave modules may both receive operational data from a source external to them, for example from computing means of the apparatus. The slave module may be configured to determine whether the master module will act on the received operational data by making a corresponding change to one or more operational parameters thereof, the slave module being arranged only to make a corresponding change to itself if it is determined that the master module will make a change.

It is to be understood that a slave module may be configured to interrogate a memory of the master module and to update one or more operational parameters of the slave module to reflect or ‘mirror’ changes made to the one or more operational parameters of the master module.

In an embodiment the master image capture module or master camera is operable to receive data corresponding to a required shot frame, e.g. a ‘one person’ shot frame in which a person sat in a prescribed position or standing in a prescribed position is made the subject of the frame and not a person sat or standing next to them. The master module may also be operable to receive data corresponding to a ‘two person’ shot frame in which the master module must zoom out and/or tilt and/or pan (and/or change one or more other operational parameters) in order to have two persons within the shot frame. The master module may be configured to provide to one or more slave modules data corresponding to the required change, responsive to which the one or more slave modules may make the required change.

The data received by the master module and/or slave module corresponding to the required operational data such as a required shot frame type may comprise data indicative of the required operational parameter value(s) or change(s) to be made thereto, e.g. data corresponding to an identifier of the required operational data value(s) such that the master module (and/or slave module) can determine the required operational data value(s) from stored data based on the identifier. Alternatively, the operational data may itself include one or more values of the operational parameters that are to be changed, or values corresponding to an amount by which an operational parameter is to be changed.

Other arrangements are also useful.

The master module may be arranged to transmit operational data to the slave module substantially continuously.

Alternatively the master module may be arranged to transmit operational data to the slave module whenever a change in an operational parameter of the master module occurs.

The master module may be arranged to transmit operational data to the slave module whenever a change in a selected one or more operational parameters of the master module occurs.

One or more operational parameters of the slave module may be arranged to be controlled independently of one or more operational parameters of the master module.

The apparatus may comprise a plurality of image capture modules.

As described above, one of the image capture modules may be a master image capture module and another one of the image capture modules may be a slave image capture module.

Advantageously the external source may comprise one selected from amongst a computing device, optionally a web server, a memory card, a disk drive, remote control apparatus or any other suitable source. The remote control apparatus may for example be a panel of a studio control desk or the like; the control desk may be in the form of a physical desk or panel or a virtual desk implemented in computer software. For the avoidance of doubt the external source may be comprised by the apparatus and need not be external to the apparatus, only to the module receiving operational data therefrom.

The external source may comprise remote control apparatus arranged to allow the image processing module to be controlled by a remote operator.

The remote control apparatus may be arranged to allow the master image processing module to be controlled by the remote operator.

The remote control apparatus may comprise wireless remote control apparatus.

The remote control apparatus may itself be configured to implement automatic control of the master module responsive to data received from a data source. The data source may correspond to content of an image projected by the projector module such as a text of a script, and/or one or more graphics. Thus the remote control apparatus may be arranged to send operational data to a master image capture module responsive to content in an image projected by the projector module. In one embodiment, when an image projected by the projector module has prescribed content, for example if it contains a certain one or more prescribed text characters, or one or more prescribed words or graphics, certain prescribed operational data is transmitted to the master module in response, in order to change one or more operational parameters.

For example, in one embodiment data defining the prescribed content for triggering an operational parameter change may include data in respect of a position of particular defined content such as a position of one or more text characters or one or more words or graphics within the projected image. For example if particular content is displayed at a prescribed line or position of an image projected by the projector module, the remote control apparatus may be arranged to transmit prescribed operational data to the master camera module. The position may for example correspond to a position of a reference prompt line on the display means, being a position of the display means signifying the position of text that is to be read by the presenter at any given moment in time.

The external source may be arranged automatically to provide operational data to the master image capture module responsive to content of an image projected by the projector module as determined from an image captured by an image capture module. That is, an image capture module may be arranged to capture an image of an image projected by a projector module. Alternatively the external source (such as a computing device as noted above) may be arranged to provide operational data to an image capture module responsive to data provided to it in respect of content of an image projected by the projector module. Thus in some embodiments apparatus providing the master image capture module or device with operational data may be provided with a feed corresponding to an image being projected by the projector module such that the apparatus providing the operational data may determine what operational data to provide.

Embodiments of the invention have the advantage that a plurality of image capture modules such as a plurality cameras and the like may be controlled in a synchronised manner effectively and efficiently. Instead of requiring a change made to an operational parameter of one camera to be made manually to each of one or more other cameras manually, the cameras may be synchronised such that a change to an operational parameter of one camera results in a corresponding change being made to one or more other cameras.

The operational data may comprise a value of one selected from amongst a colour setting, a white balance setting, an iris setting, a focus setting, a zoom setting, a pan setting and a tilt setting.

It is to be understood that data in respect of the value of one or more operational parameters or settings of one or more of the image capture modules (such as the master image capture module) may also be provided to one or more other apparatus or systems. For example one or more other systems such as a lighting system or sound system (such as a microphone controller) may be arranged to control lighting and/or a microphone responsive to the value of one or more operational parameters or settings output by the present apparatus.

It is to be understood that a computing system arranged to render special effects such as one or more features of a ‘virtual studio’ environment may require data in respect of the value of one or more operational parameters of an image capture module. Thus, in order to generate correctly the required effects to be combined with an image captured by an image capture module, the computing system may require data in respect of (say) a zoom, pan and tilt setting of an image capture module. This data can be readily provided by apparatus according to some embodiments of the present invention.

It is to be understood that in some virtual studio systems, computer generated sets/surroundings for presenters or the like within a studio can be generated. The computing system may generate one or more graphics that can ‘appear’ to a viewer to be in the studio, for example a word or an image. The graphic may be 3D in some embodiments. The studio or other environment may be electronically ‘mapped’ and the computer generated content then placed within the environment by combining computer generated images with images captured by an image capture module, for example a video feed of a presenter from one of the image capture modules. The image capture module may be arranged to capture an image of the user transmitted through the reflector member.

Alternatively the image capture module may be arranged to capture an image of the user reflected by the reflector member

The image projection module may be arranged to project an image onto the reflector member by means of one or reflector members.

The one or more reflector members may have a curved form arranged to project an image onto the screen such that the image as viewed by the user is substantially undistorted.

The image processing modules may be provided substantially coplanar with the reflector member.

In some embodiments a data storage device is provided that is operable to store operational data therein for the camera module. The data storage device may be further operable to store operational data for a plurality of camera modules.

As noted above the operational data may be obtained from a data storage device. The storage device may be a remote storage device accessed by a wireless communications device such as an infra-red communications device, a Bluetooth® device, a GSM device, a wi-fi device or any other suitable wireless device. Alternatively the remote storage device may be accessed by a wired connection.

In an aspect of the invention there is provided apparatus comprising: at least one camera device; at least one image projection module; and a display means, the image projection module being arranged to project an image onto the display means for viewing by a user, the at least one camera device being arranged to generate an image of a user, the display means being provided in an optical path from a user to the at least one camera device, wherein the apparatus is operable to control a displayed image responsive to detection of one or more features in one or more images captured by the at least one camera device.

Reference to control of a displayed image is to be understood to include control of a content of a displayed image and optionally a position of the content, such as words, graphical symbols or images. For example controlling position of content of a displayed image, such as a position of graphics such as text, an image, a logo or the like.

The camera device may be an image capture module in some embodiments. It is to be understood that a camera device or image capture module may be arranged to store data corresponding to a frame of an image formed by the device or module and to transmit the image frame data from the device or module. Alternatively the camera device or image capture module may be arranged to transmit image data substantially without storing the data. The device or module may be arranged to output the data via a wired or wireless connection. Other arrangements are also useful.

Embodiments of the invention have the advantage that in some arrangements a user may control the content of an image that is provided to them on the display means, since content of the displayed image is provided responsive to the detection of one or more features in one or more images captured by the at least one camera device. Thus a user may control the scrolling of displayed prompting text, an animation such as a weather pattern animation, or any other suitable graphical content.

Furthermore, in some embodiments, because the display means is provided in the optical path from the user to the at least one camera device, an image generated by the at least one camera device may create an illusion that the user is looking directly at the at least one camera device regardless of a physical position of the at least one camera device with respect to the user.

It is to be understood that some embodiments of the invention are useful in broadcast environments in which a user is a presenter and the image provided to the presenter is a script for a presentation made by the presenter. The presenter may for example control scrolling of the script by making one or more gestures such as a particular movement of a head, limb, finger, thumb, eye or other body feature, by looking in a particular direction, or any other means by which a user may cause computer-recognisable content to be found in one or more images captured. Other applications are also useful such as teleconference applications, security applications such as access control, and a number of other applications.

It is to be understood that by optical path is meant a path of light from the user to the image capture module, at least a a portion of the path being along a line of sight viewing direction of the at least one camera device.

Optionally the at least one camera device is arranged to capture light transmitted through the display means thereby to generate an image of a user.

Optionally the at least one camera device is arranged to capture light scattered by the display means thereby to generate an image of a user.

Further optionally the at least one camera device is arranged to capture light from a user scattered by the display means on the same side of the display means as that on which the light is incident on the display means thereby to generate the image of a user.

In some embodiments the at least one camera may be arranged to capture light from a user scattered by the display means that has not been transmitted through the display means.

Advantageously the display means may comprise a reflector member arranged partially to reflect and partially to transmit visible light incident thereon.

Optionally the display means is arranged to scatter light incident thereon from the image projection module towards a user.

Further optionally the image projection module is arranged to project light onto the display means on a same side of the display means as that from which a user views the display means.

Advantageously the apparatus may be operable to control the displayed image responsive to detection of one or more objects identified in one or more images generated by the at least one camera device.

It is to be understood that by object is included a portion of an object.

Further advantageously the apparatus may be operable to control the displayed image responsive to detection of a prescribed sequence of movements of one or more objects or part of an object between a plurality of images generated by the at least one camera device.

Advantageously the object may comprise at least a portion of a face of a person, the apparatus being operable to control the displayed image responsive to recognition of at least a portion of a face.

The apparatus may be operable to control the displayed image responsive to recognition of one or more biometric features of a person. The one or more biometric features may include one or more features of an eye such as a retina, an iris, a face or portion thereof, a finger, a thumb or any other feature.

It is to be understood that retinal or iris features, facial features, finger or thumb prints and the like are highly person-specific and allow reliable discrimination between persons.

In some embodiments the apparatus may be provided with voice recognition capability. The apparatus may be operable to control the displayed image responsive to detection of a particular person's voice and/or a particular sound, word or group of sounds and/or words such as a sound or word spoken by any person.

The apparatus may be arranged control the displayed image responsive to detection of a non-spoken sound such as a finger click, a tap of a foot or any other sound.

In some embodiments the apparatus may be arranged to use voice control to control scrolling of displayed text, for example for reading by a presenter. In some embodiments scrolling may be controlled responsive to recognition of one or more words, or one or more constituent letters and/or syllables of one or more words. For example in some embodiments the apparatus may detect one or more words of displayed text and control scrolling of the text responsive to detection of the one or more words. Thus the apparatus may determine automatically when a reader has reached a prescribed point in a script and scroll the text accordingly. For example, the apparatus may detect when a presenter is at the beginning of a last line of displayed text, in the middle of the last line, or at or near the end of a penultimate line of displayed text. Other arrangements are also useful.

In some embodiments the apparatus may be arranged to identify one or more gaps or spaces between words and control scrolling accordingly.

The apparatus may be arranged to control the image only in response to recognition of the voice of a particular person or set of persons, or recognition of a biometric feature of a particular person or set of persons.

In some embodiments the apparatus may be arranged to allow gesture or other control only by a prescribed one or more persons.

In some embodiments, the apparatus may control content of a displayed image in one way when a certain person is identified, and in a different way when a different person is identified. Thus in one arrangement, if the apparatus identifies a particular person in an image or recognises a particular person's voice, the apparatus may perform one function (e.g. scrolling of text or of prescribed text) whereas if a different person is identified in an image (or by voice) a different function, such as scrolling of different text, or no scrolling, may be performed.

Further advantageously the apparatus may be operable to communicate information in the form of an audible signal responsive to recognition of one or more objects.

The audible signal may for example be a voice communication or another audible signal communicating information.

Advantageously the apparatus may be operable to display information responsive to recognition of one or more objects.

The apparatus may be operable to obtain information for display from a database.

Optionally the information corresponds to an identifier of one or more objects.

The identifier may for example be a name of the object or information about the object such as a size, a shape, a colour or other information in addition or instead. The identifier may be in the form of text or an icon indicating an identity of an object.

In the case that the apparatus is employed for the purpose of a video communication or broadcast (whether online, via a cable network, satellite network or other network) the apparatus may be configured to display the name of a person identified.

The apparatus may be operable to control the displayed image responsive to recognition of a movement of a person.

Optionally a movement may correspond to movement of one selected from amongst an eye, a head, a hand, a leg and a foot.

The apparatus may be operable to control the displayed image responsive to recognition of a movement.

In some embodiments the apparatus may be operable as a prompting apparatus to display text for reading by a user. A user may be a presenter such as a television presenter, or a member of a teleconference, or any other person in a given application.

Thus embodiments of the invention are useful in applications where two-way or one-way communication is effected in a ‘one to one’ remote meeting application, or a ‘one to many’ remote meeting, conference or broadcast application. Other applications are also useful.

As described further below, the apparatus may be operable to change displayed text such as by scrolling responsive to detection of movement such as eye movement. In some embodiments the apparatus is operable to detect that a user has read a section of text and to display automatically further text responsive to detection that a user has read the section. The apparatus may be arranged to determine that a user has read text responsive to a detected position of a user's eye (for example a position corresponding to that when a user is looking at a particular word, portion of text, and/or a prescribed position of the display) or responsive to detection that an eye or eyes of a user have scanned across the display a prescribed number of times, for example a number corresponding to the number of lines of text displayed or fraction thereof to facilitate scrolling. Other arrangements are also useful.

The apparatus may be arranged to change one or more other graphic types displayed on the display portion in addition to or instead of text, or any other suitable information provided to a user. For example the apparatus may change a displayed image from one image to another image. A displayed image may be of a different subject or scene, or an enlarged view such as an enlarged view of a meteorological map or the like. An animation may be stopped and/or started for example.

Thus for example the apparatus may be arranged to change a graphic displayed by the apparatus whenever a user such as a presenter looks in a particular direction, for example a direction corresponding to a particular area of an image captured by the camera device.

Advantageously the apparatus may be operable to change an image displayed responsive to recognition of movement of an eye.

Further advantageously the apparatus may be operable to change an image displayed responsive to recognition of movement of an eye in a prescribed direction.

Thus the apparatus may be arranged to change an image displayed on the display means responsive to movement of an eye of a user in a particular direction or to a particular viewing direction, such as to a location of the display means at which a last word of a particular sentence is displayed.

Advantageously the apparatus may be operable to change an image displayed responsive to recognition that a user's eye is looking in a particular direction. It is to be understood that one or more image processing algorithms may be employed to determine in which direction a user's eye is looking at a given moment in time. Such algorithms may be referred to as ‘eye tracking’ algorithms.

Optionally the apparatus is operable to change an image displayed responsive to recognition that at least one selected from amongst a user's hand, arm and finger is pointing in a particular direction.

The apparatus may be operable to control the displayed image whereby text or graphic content of a displayed image is changed.

The apparatus may be operable to change text or graphics displayed by scrolling.

Alternatively or in addition the apparatus may be operable to change an image or text or graphic content of an image by enlarging or reducing a size of an image or content of an image.

Advantageously the apparatus may be operable to inhibit one or more functions of the apparatus responsive to detection of one or more features of one or more images captured by the at least one camera device.

For example in the case of apparatus employed for the purpose of video conferencing, the apparatus may be arranged only to allow certain persons to use the apparatus The apparatus may be operable to allow or inhibit one or more functions responsive to detection of one or more features of their face, or any other feature of the person including visible or audible features.

The apparatus may be operable to control the displayed image to display an image of a user viewing the display means.

The apparatus may be operable to provide to a remote user an image captured by the camera device.

Advantageously the apparatus may be operable to provide information to a remote user responsive to an image captured by the camera device.

The apparatus may be operable to display said identifier to a remote user.

The apparatus may be operable to provide information to a remote viewer in the form of an audible signal.

The identifier may be in the form of an audible identifier.

Embodiments of the invention are useful in security applications. For example in domestic or industrial security applications where a visitor to a building may be required to request entry by pressing a button and await permission to enter. The user may be requested to read instructions displayed on the display means, the apparatus being arranged to capture an image of the person. Thus, in one embodiment the apparatus is provided having a camera device arranged to capture an image of a person and to transmit the image to a remote user for viewing on a screen. The apparatus provides the captured image of the person (or portion of the captured image) and (by way of example) text or other graphical content identifying the person.

In some arrangements the apparatus may be arranged to identify a person responsive to one or more facial features, an iris scan or other biometric inspection; voice recognition may be employed in addition or instead.

Advantageously the apparatus may be operable to provide a captured image to a remote user only if the apparatus determines that the one or more features identified in an image correspond to a prescribed one or more features.

The apparatus may be operable to provide to a remote user an image of a person only if the apparatus recognises a person as corresponding to an authorised person.

An authorised person may be a person in respect of whom data is stored in a database accessible to the apparatus. Alternatively an authorised person may be a person in respect of whom data is not stored in the database. The database may contain data in respect of a plurality of persons, and an indication as to whether a particular person is authorised or not. The database may be an online database or a database stored in a memory of the apparatus.

In the case of a security application such as an application in respect of security of an apartment block, a visitor may be required to press a button corresponding to an apartment to be visited. The apparatus may be arranged to capture an image of the visitor and transmit the image to a host in one of the apartments. The apparatus may be arranged to determine whether the visitor corresponds to a person whose biometric data is stored in a database associated with the host or their apartment. The database may include data corresponding to friends, family members, police officers, care workers or the like.

The apparatus may comprise a plurality of camera devices, a first camera device being operable to capture an image of a face of a person, a second camera device being operable to capture an image of an eye of a person, an image of an eye of a person captured by the second device having a higher resolution than a corresponding image of an eye of a person captured by the first device.

Advantageously the apparatus may be operable to control the second camera device responsive to an image captured by the first camera device.

Thus the second camera device may be controlled by the apparatus to capture an image of an eye responsive to eye location information determined by reference to an image captured by the first camera device.

In some embodiments the apparatus may be arranged to display information on the reflector member to a viewer of the reflector member such as instructions or other text and to capture an image of the viewer (e.g. an image reflected by or transmitted through the reflector member) thereby to perform a biometric identification. The apparatus may be arranged to determine whether data acquired by the apparatus from the captured image for that person corresponds to that of a dataset that is alleged to correspond to that person. The dataset may be a dataset provided by or identified in an identification document or other item such as a passport, a bank card of the like. Thus in some embodiments the apparatus may be provided in a security installation such as at an airport where a passenger is required to view the screen before, during or after a dataset in respect of that person is obtained, e.g. from a passport. The apparatus may be arranged to determine whether the dataset corresponds to that person responsive to analysis of an image captured by the apparatus.

Embodiments of the invention have the advantage that the person viewing the reflector member looks directly or substantially directly along an optical path leading to the image capture module or camera device obtaining an image of the person. In some known biometric identification apparatus the display of information such as instructions is provided below the camera device and therefore the camera device is not able to obtain an image of the person looking substantially directly at the camera device.

The apparatus may be operable to perform a further one or more actions responsive to detection of one or more features of one or more images captured by the at least one camera device.

Advantageously the apparatus may be operable to provide an output signal to one or more other apparatus or modules corresponding to detection of the one or more features. The other apparatus or modules may for example comprise a sound control system such as a microphone control system, a speaker control system, a lighting control system or any other suitable system.

Advantageously the apparatus may be operable to provide an output signal to control an access portal.

The access portal may be a barrier such as a door or a gate or any other suitable access portal.

The apparatus may be operable to dispense one or more articles to a user responsive to recognition of a face of a user.

The apparatus may comprise means for dispensing currency to a user.

Thus in some embodiments the apparatus may be provided in association with banking or like apparatus such as a cash machine, where the reflector member provides a display of information projected thereon from an image projection device. An image of a customer reflected by the reflector member is captured by a camera device of the apparatus. The image is then compared with biometric data associated with a bank card presented to the cash machine in order to determine whether bank records confirm that the customer is in fact associated with the bank card presented.

In some embodiments the apparatus may be operable to change the image provided to the viewer responsive to movement such as an eye movement, a gesture such as a movement of a head (such as a nod), a hand movement, a leg or foot movement or any other gesture visible to the at least one camera device.

Other arrangements are also useful.

In one aspect of the invention there is provided prompting apparatus comprising an image capture device and a display device, the apparatus being operable to display by means of the display device text for reading by a presenter, the apparatus being operable to capture or otherwise acquire a series of images of the presenter, the apparatus being further operable to change the text displayed responsive to detection of a prescribed feature of one or more of the series of captured or acquired images.

The prescribed feature may be any feature including a movement in the image, as described above with reference to the previous embodiment.

In a further aspect of the invention for which protection is sought there is provided a method comprising: obtaining an image of a user by means of at least one camera device; projecting by means of image projection means an image onto display means for viewing by a user, whereby the display means is provided in an optical path from a user to the at least one camera device, the method further comprising detecting one or more features of one or more images captured by the at least one camera device and controlling automatically the image projection module responsive to detection of one or more features.

It is to be understood that reference to the detection of one or more features in one or more images may include detection of one or more features in a single image, such as one or more features indicative of an identity of a user.

In a still further aspect of the invention for which protection is sought there is provided apparatus comprising an image capture device and a display device, the apparatus being operable to display by means of the display device text for reading by a person, the apparatus being operable to capture an image of the person, the apparatus being further operable to change the text displayed responsive to detection of a prescribed feature of the captured image.

The prescribed feature may be any feature including a movement in the image, as described above with reference to the previous embodiment.

The person may be a presenter or an attendee of a teleconference, an internet chat-room or any other person. The apparatus may be configured to function as a prompting apparatus.

In one aspect of the invention for which protection is sought there is provided apparatus comprising an image capture device and a display device, the apparatus being operable to display by means of the display device an image to the person, the apparatus being operable to capture a series of images of the person, the apparatus being further operable to change the displayed image responsive to detection of a prescribed feature of one or more of the captured images.

The displayed image may be a graphical image such as a photograph, a diagram, data, a map such as a meteorological (or weather) map, text, or any other suitable image.

In an embodiment of the invention for which protection is sought there is provided apparatus comprising: at least one image capture module and at least one image projection module; and a reflector member, the image projection module being arranged to project an image onto the reflector member for viewing by a user, the image capture module being arranged to capture an image of the user via the reflector member.

The apparatus may be operable to change the image provided to the viewer responsive to detection of one or more features of a stream of images captured by said at least one image capture module.

The feature may correspond to the presence of a feature or object identified in the stream of images. Alternatively or in addition the feature may correspond to a prescribed sequence of movements of one or more features such as movement of an object or person.

For example the feature may be the face of a particular person. The apparatus may be arranged to perform a function responsive to recognition of the face such as displaying an identifier of the person such as the name of the person. Thus, in the case that the apparatus is employed for the purpose of a video broadcast (whether online, via a cable network, satellite network or other network) the apparatus may be configured to display the name of the person identified by it.

In addition or instead the apparatus may be arranged to allow or to prevent certain functionality of the apparatus to be employed responsive to the detection of a particular feature. For example in the case of apparatus employed for the purpose of video conferencing, the apparatus may be arranged only to allow certain persons to use the apparatus, the apparatus being responsive to detection of one or more features of their face.

In some embodiments apparatus according to an embodiment of the invention is arranged to identify a person responsive to one or more retinal features. It is to be understood that retinal features are highly person-specific and allow reliable discrimination between persons.

In some embodiments the apparatus is arranged to identify an object from an image captured by the image capture module and to provide to a remote viewer an image of the object and an identifier. The identifier may be in the form of a text or icon indicating an identity of the person. Alternatively or in addition the identifier may be in the form of an audible identifier. Such embodiments are useful in security applications. For example in domestic or industrial security applications where a visitor to a building may be required to request entry by pressing a button and await permission to enter.

In one application apparatus may be provided having an image capture module arranged to capture an image of a person and transmit the image to a remote viewer for viewing on a screen. The apparatus provides an image of the person and a text identifying the person.

In some arrangements the apparatus may be arranged to identify the person responsive to one or more facial features, an iris scan or other biometric inspection. The apparatus may be arranged to communicate an image of a person to the remote viewer if the person is an authorised person.

In some embodiments the apparatus may be arranged to determine whether a person is an authorised person by reference to a database. The database may be an online database or a database stored in a memory of the apparatus.

Thus in the case of a domestic security application such as security of an apartment block, a visitor may be required to press a button corresponding to an apartment to be visited. The apparatus may be arranged to capture an image of the visitor and transmit the image to a host in one of the apartments. The apparatus may be arranged to determine whether the visitor corresponds to a person whose biometric data is stored in a database associated with the host or their apartment. The database may include data corresponding to friends, family members, police officers, care workers or the like.

The apparatus may comprise a plurality of image capture modules, a first module arranged to capture an image of a face of the visitor and a second module arranged to capture a close-up image of an eye of the visitor. The second module may arranged to determine a location of the eye of the visitor responsive to eye location information determined by reference to the image captured by the first module.

In some embodiments the apparatus is arranged to display information on the reflector member to a viewer of the screen such as instructions or other text and to capture an image of the viewer reflected by the screen thereby to perform a biometric identification. The apparatus may be arranged to determine whether the person corresponds to a dataset that is alleged to correspond to that person. The dataset may be a dataset provided by or identified in an identification document or other item such as a passport, a bank card of the like. Thus in some embodiments the apparatus may be provided in a security installation such as at an airport where a passenger is required to view the screen before, during or after a dataset in respect of that person is obtained, e.g. from a passport. The apparatus may be arranged to determine whether the dataset corresponds to that person responsive to analysis of an image captured by the apparatus.

Embodiments of the invention have the advantage that the person viewing the reflector member looks directly or substantially directly along a line of sight of the image capture apparatus capturing an image of the person. In some known biometric identification apparatus the display of information such as instructions is provided below the image capture means and therefore the image capture apparatus is not able to obtain an image of the person looking substantially directly at the image capture apparatus.

In some embodiments the apparatus is provided in association with banking or like apparatus such as a cash machine, where the reflector member provides a display of information projected thereon from an image projection device. An image of a customer reflected by the reflector member is captured by an image capture device of the apparatus. The image is then compared with biometric data associated with a bank card presented to the cash machine in order to determine whether bank records confirm that the customer is in fact associated with the bank card presented.

In some embodiments the apparatus is operable to change the image provided to the viewer responsive to movement such as an eye movement, a gesture such as a movement of a head (such as a nod), a hand movement, a leg or foot movement or any other gesture visible to the at least one image capture apparatus.

In some embodiments the apparatus may be operable as a prompting apparatus to display text for reading by the viewer. The viewer may be a presenter such as a television presenter, or a member of a teleconference, or any other person in a given application. Thus embodiments of the invention are useful in applications where two-way or one-way communication is effected in a ‘one to one’ remote meeting application, or a ‘one to many’ remote meeting, conference or broadcast application.

The apparatus may be operable to change the text such as by scrolling responsive to detection of movement such as eye movement. In some embodiments the apparatus is operable to detect that a user has read a section of text and to display automatically further text responsive to detection that the user has read the section. The apparatus may be arranged to determine that a user has read the text responsive to a detected position of the user's eye (for example a position corresponding to that when a user is looking at a particular word, portion of text, and/or a prescribed position of the screen) or responsive to detection that the eye or eyes of the user have scanned across the screen a prescribed number of times, for example a number corresponding to the number of lines of text displayed or fraction thereof to facilitate scrolling. Other arrangements are also useful.

The apparatus may be arranged to change one or more graphics of the display in addition to or instead of text, or any other suitable information provided to a viewer. For example the apparatus may change a displayed image from one to another. The displayed image may be of a different subject or scene, or an enlarged view such as an enlarged view of a meteorological map or the like.

Thus for example the apparatus may be arranged to change a graphic displayed by the apparatus whenever the presented looks in a particular direction, for example a direction corresponding to a particular area of an image of the presenter captured by the image capture device.

In some embodiments the apparatus is operable to provide an output signal to one or more other apparatus or modules corresponding to detection of the prescribed feature.

Other arrangements are also useful.

In one aspect of the invention for which protection is sought there is provided prompting apparatus comprising an image capture device and a display device, the apparatus being operable to display by means of the display device text for reading by a presenter, the apparatus being operable to capture a series of images of the presenter, the apparatus being further operable to change the text displayed responsive to detection of a prescribed feature of one or more of the series of captured images.

The prescribed feature may be any feature including a movement in the image, as described above with reference to the previous embodiment.

It is to be understood that the image capture device may not store the series of captured images referred to above. Rather, in some embodiments the image capture device outputs frames of images as the frames are captured, for processing. For example respective frames may be processed to detect a prescribed one or more gestures made by a person an image of whom is contained within a series of images, for example movement of a hand, eye, arm or other gesture.

In a further aspect of the invention for which protection is sought there is provided apparatus comprising an image capture device and a display device, the apparatus being operable to display by means of the display device text for reading by a person, the apparatus being operable to capture an image of the person, the apparatus being further operable to change the text displayed responsive to detection of a prescribed feature of the captured image.

The prescribed feature may be any feature including a movement detected by comparing content of respective capture images, as described above, for example with reference to the previous embodiment.

The person may be a presenter or an attendee of a teleconference, an internet chat-room or any other person. The apparatus may be configured to function as a prompting apparatus.

In one aspect of the invention for which protection is sought there is provided apparatus comprising an image capture device and a display device, the apparatus being operable to display by means of the display device an image to the person, the apparatus being operable to capture a series of images of the person, the apparatus being further operable to change the displayed image responsive to detection of a prescribed feature of one or more of the captured images.

The displayed image may be a graphical image such as a photograph, a diagram, data, a map such as a meteorological (or weather) map, text, or any other suitable image.

In one aspect of the invention for which protection is sought there is provided apparatus comprising: a plurality of image processing devices, each image processing device being one selected from amongst an image capture device and an image projection device, the apparatus comprising at least one image capture device and at least one image projection device; and a reflector member, the image projection device being arranged to project an image onto the reflector member for viewing by a user, the image capture device being arranged to capture an image of the user via the reflector member, at least one of the image processing devices being arranged to receive operational data from a source external to the device.

The external source may be part of the apparatus.

Features, integers or characteristics described in conjunction with a particular aspect, embodiment or example of the invention above or below are to be understood to be applicable to any other aspect, embodiment or example described herein unless incompatible therewith.

### BRIEF DESCRIPTION OF THE DRAWINGS

Embodiments of the invention will now be described with reference to the accompanying figures in which:

FIG. 1 is a schematic illustration of apparatus according to an embodiment of the invention in which two image capture modules and an image projection module are arranged out of a line of sight of a user;

FIG. 2 is a schematic illustration of apparatus according to further embodiments of the invention in which an image capture module and an image projection module are arranged out of a line of sight of a user;

FIG. 3 is a schematic illustration of apparatus according to an embodiment of the invention in which an image capture module is positioned in a direct line of sight of a user and an image projection module is arranged out of the direct line of sight of the user; and

FIG. 4 is a schematic illustration of apparatus according to a further embodiment of the invention.

### DETAILED DESCRIPTION

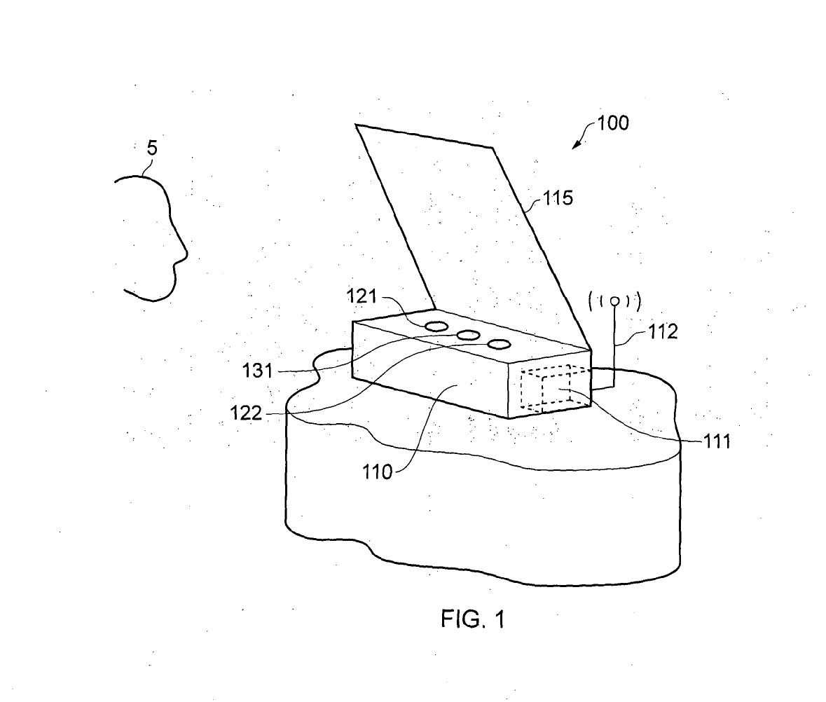

In one embodiment of the invention communications apparatus 100 is provided substantially as shown in FIG. 1. The apparatus 100 is suitable for use as a replacement for an autocue system in a broadcasting environment. In some applications the apparatus 100 is also suitable for use as a replacement for a broadcast camera.

The apparatus 100 has a basal housing 110 in which is provided first and second camera modules 121, 122 and a projector module 131. A reflector member 115 is hingedly coupled to the basal housing 110.

In use, the apparatus 100 is arranged such that the projector module 110 projects an image onto the reflector member 115 for viewing by a presenter 5. The image may contain text to be read by the presenter or an image of a person with whom the presenter 5 is speaking, such as a colleague or an interviewee. Other arrangements are also useful. For example the image may be of video footage upon which the presenter 5 is providing a commentary.

The camera modules 121, 122 may be arranged simultaneously to capture an image of the presenter 5 reflected by the reflector member 115 to the camera modules 121, 122.

In the embodiment shown the first camera module 121 is a master camera module and the second camera module 122 is a slave camera module. The slave camera module 122 is arranged to receive data from the master camera module 121 when one of a prescribed subset of operating parameters of the master camera module 121 change.

In the embodiment of FIG. 1 if a colour balance setting, a white balance setting, an iris setting, a zoom setting, a pan setting, an aperture setting, a shutter speed setting, a gain control, or an aspect ratio of the master camera module 121 is changed (either by an automatic controller of the module 121 or by an operator) a corresponding change is made to settings of the slave camera module 122. Other arrangements are also useful. In some embodiments only a prescribed one or more of the above mentioned settings are changed automatically for the slave module 122 responsive to a corresponding change to the master module 121.

It is to be understood that the camera modules 121, 122 may be ‘synchronised’ with one another and/or one or more other camera modules or equipment. Thus for example in some arrangements the modules are synchronised such that they each operate at the same field (or frame) rate.

In some embodiments shot framing is also synchronised such that if the master camera module is centred on a particular feature of a scene other camera modules may be controlled also to be centred on the feature. Shot framing may be accomplished for example by means of image feature recognition technology.

The apparatus 100 may be operable automatically to synchronise shot framing of the slave camera module 122 to the master module 121. Alternatively the apparatus 100 may be operable to synchronise shot framing upon demand by an operator.

In some arrangements shot framing may be synchronised such that one or more slave camera modules perform re-framing together including one or more of zooming, panning, tracking and craning.

Thus it is to be understood that in some embodiments the camera modules may be located remotely from one another and be controlled by mechanical actuators to pan and/or be translated in a horizontal and/or vertical plane in synchrony.

In the embodiment of FIG. 1 the camera module 121 is arranged to be controlled remotely by an operator. Thus, the camera module 121 may be coupled to a wireless communications device 111 in the basal housing, the device 111 having an antenna 112 to facilitate wireless communications. The wireless communications device 111 is operable wirelessly to receive settings data from the operator and to control the camera module 121 in accordance with the settings data received.

Thus, if the remote operator wishes to zoom in on the presenter 5 and to pan and/or tilt the camera module 121 to change a position of the presenter 5 within a field of view of the camera module 121, the operator may send a signal to the camera module 121 (being the master camera module 121) to change the zoom, pan and/or tilt operational parameters.

The master camera module 121 in turn sends a control signal to the slave camera module 122 to adjust corresponding zoom, pan and/or tilt operational parameters thereof.

In some embodiments the respective camera modules 121, 122 may be arranged to provide signals for processing by different respective broadcasting companies. This has the advantage that a signal from one camera does not have to be provided to a plurality of different feed channels such as feed channels of the respective companies. This feature eliminates a requirement to provide apparatus for providing multiple video feeds from a single video signal.

Providing multiple video feeds from a single video signal can present a number of technical issues, particularly where respective video feeds are required to provide signals in different respective formats such as PAL, NTSC, a high definition (HD) format or other type of format. An operator of the broadcasting facility may not have apparatus for providing the required feeds.

Thus, embodiments of the invention have the advantage that substantially any type of image capture module of suitable size may be used with the apparatus 100 and provide the desired video feed directly to the corresponding broadcast company. The image capture module may for example be coupled to or otherwise mounted to the apparatus 100. Thus, a broadcast company requiring a particular video feed may provide to the operator of the apparatus 100 a camera module 121, 122 arranged to provide the desired feed. The operator can then provide this feed to the company without a requirement to provide multiple video feeds from a single camera.

Furthermore, a single operator can operate a plurality of camera modules since one of the camera modules 121 may be operated as a master camera module 121, the apparatus being arranged to control the further camera module 122 as a slave module 122 in a corresponding manner.

It is to be understood that when setting up the apparatus the operator may be required to align the master and slave camera modules 121, 122 such that for a given set of operational parameters of the master camera module 121 the slave camera module 122 is provided with appropriate values of those operational parameters.

In one method, a set-up routine is performed prior to employment of the apparatus in which the master camera module 121 is controlled manually so as to assume a range of values of a given set of operational parameters such as pan, zoom, tilt, iris and focus and the slave camera module 122 is controlled manually in a corresponding manner to assume corresponding values of those operational parameters. The apparatus is arranged to store the corresponding values of the respective operational parameters for the master and slave modules such that in use the apparatus can generate a set of values of operational parameters for the slave module for a given set of values of operational parameters of the master module. Other arrangements for reproducing a set of values of operational parameters for the slave module corresponding to those of the master module are also useful.

In some embodiment one camera module 121 may be a studio quality camera module for broadcast over a cable or satellite television channel. The other camera module 122 may be adapted to provide a signal for broadcast over the internet. Alternatively one camera module may be arranged to generate a PAL HD video feed and the other arranged to generate a PAL non-HD feed or NTSC feed.

Embodiments of the invention have the advantage that a plurality of different video feeds may be provided from a corresponding plurality of camera modules 121, 122. The camera modules 121, 122 may be controlled by a single operator controlling one of the cameras directly (the master camera module 121) and the slave camera module 122 indirectly as a consequence of controlling the master camera module 121.

It is to be understood that in some embodiments the operator may additionally send one or more control signals to a slave camera module 122 to adjust one or more operational parameters thereof.

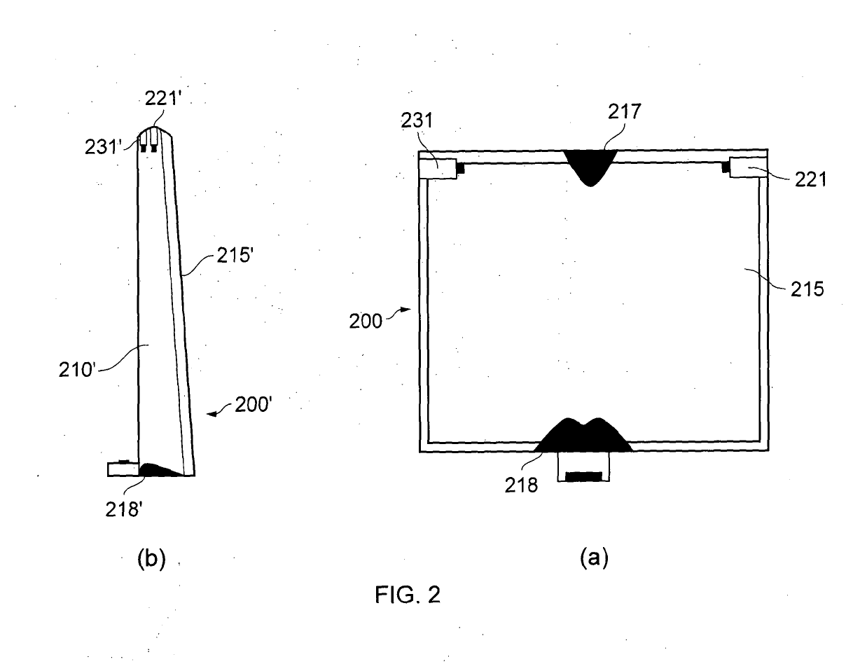

FIG. 2(a) shows an embodiment of the invention in which apparatus 200 is provided suitable for mounting on a desktop for use in broadcast or video conferencing applications. The embodiment shown is particularly useful in environments in which space is at a premium.

The apparatus 200 has a housing 210 arranged to support a screen member 215 arranged to scatter light incident thereon for viewing by a user. In some embodiments the screen member 215 is arranged diffusely to scatter light incident thereon. In some alternative embodiments the screen member 215 may be arranged to reflect substantially non-diffusively light incident thereon in the manner of a reflector.

A projector module 231 is arranged to project an image onto the screen member 215 via first and second intermediate reflector members 217, 218. The first intermediate reflector member 217 is positioned in a direct line of sight of the projector module 231 and is arranged to reflect light from the projector module 231 onto both a portion of the screen 215 and the second intermediate reflector member 218. The second intermediate reflector member 218 is arranged in turn to reflect light from the first intermediate reflector member 217 onto the screen 215.

In some embodiments the second intermediate reflector member 218 is arranged also to reflect a portion of the light from the first intermediate reflector member 217 back to a further portion of the first intermediate reflector member 217 for reflection onto a further area of the screen 215.

It is to be understood that the first and second intermediate reflector members 217, 218 may be formed to have respective curvatures such that the image projected by the projector member 231 as reflected by the screen member 215 to a person viewing the screen is substantially undistorted. In some embodiments the image projected by the projector module 231 may have portions thereof of modified brightness relative to that of the image it is required to present to the user in order to compensate for brightness variations due to the arrangement of the intermediate reflector members 217, 218.

Thus it is to be understood that in order to form an image of uniform brightness on the screen 215, the image projected by the projector module 231 may be required to be brighter in areas of the projected image that correspond to areas of the screen member 215 further away from the intermediate reflector member 217, 218 providing light to that area.

A camera module 221 is also provided, the camera module 221 being arranged to capture an image of the user facing the screen 215. In the embodiment shown the camera module 221 is arranged to capture an image of the user from the first intermediate reflector member 217 in a similar manner to which the projector module 231 is arranged to project to the first intermediate reflector member 217 an image for viewing by the user.

It is to be understood that other arrangements are also useful.

FIG. 2(b) shows an embodiment of the invention in which apparatus 200′ is provided similar to that shown in FIG. 2(a). Like features are labelled with like reference signs suffixed prime.

The embodiment of FIG. 2(b) differs from that of FIG. 2(a) in that upper mirror 217 of the embodiment of FIG. 2(a) is not provided. Rather, the projector module 231′ and camera module 221′ are arranged to point directly towards the intermediate reflector member 218′ provided at an opposite edge of the screen member 215′.

In the embodiment of FIG. 2(b) the projector module 231′ and camera module 221′ are arranged to point substantially vertically downwards although in other embodiments the modules 231′, 221′ may point in another direction. The modules 231′, 221′ are arranged such that their optic axes are substantially parallel although in some alternative embodiments their axes are non-parallel.

The intermediate reflector member 218′ is arranged to reflect an image projected thereon by the projector module 231′ onto the screen 215′ for viewing by a viewer. In a reciprocal manner the reflector member 218′ also reflects an image falling thereon from the screen 215′ towards the camera module 221′.

It is to be understood that the reflector member 218′ is shaped in such a manner that the image projected by the projector module 231′ as incident on the screen member 215′ (and reflected therefrom towards a viewer) is substantially undistorted.

It is to be understood that other arrangements are also useful.

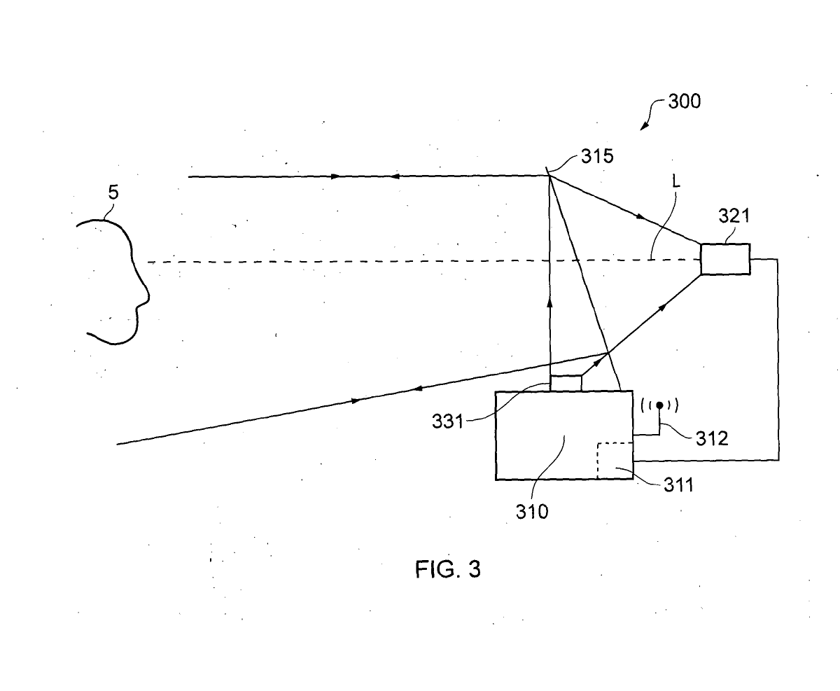

FIG. 3 shows apparatus 300 according to a further embodiment of the invention. Like features of the embodiment of FIG. 3 to those of the embodiment of FIG. 1 are provided with like reference signs prefixed numeral 3 instead of numeral 1. In the embodiment of FIG. 3 a camera module 321 is provided in direct line of sight of the presenter (or user) 5. It is to be understood that in the embodiments of FIG. 1 and FIG. 2 described above the camera module 321 is not provided in a direct line of sight of the presenter 5.

In the embodiment of FIG. 3 the camera 321 is arranged to capture an image of the presenter 5 as viewed through a reflector member 315 along a direct line of sight L. Simultaneously a projector module 331 is arranged to project onto the reflector member 315 an image that is to be viewed by the presenter 5. It is to be understood that the reflector member 315 is in the form of a partially transparent, partially reflective member.

In the embodiment shown the camera module 321 is arranged to receive data in respect of one or more required operational parameters of the module 321 by means of a wireless communications device 311 having an antenna 312.

In some embodiments, the camera module 321 is a master camera module 321 and one or more further camera modules may be co-located with the camera module 321. In some alternative embodiments one or more further camera modules may be provided in the basal housing 310 instead of or in addition to being co-located with the camera module 321. The one or more further camera modules may be ‘slave’ modules. The master camera module 321 may be arranged to output data corresponding to one or more operational parameters or settings thereof to the one or more slave camera modules. The one or more slave camera modules may be arranged in turn to assume one or more operational parameter values or settings corresponding to those of the master camera module.

It is to be understood that camera modules suitable for use in some embodiments of the invention may be provided with actuatable mounts such as motorised mounts operable to adjust a pan and tilt setting of the camera, for example by rotation of the camera about respective orthogonal axes.

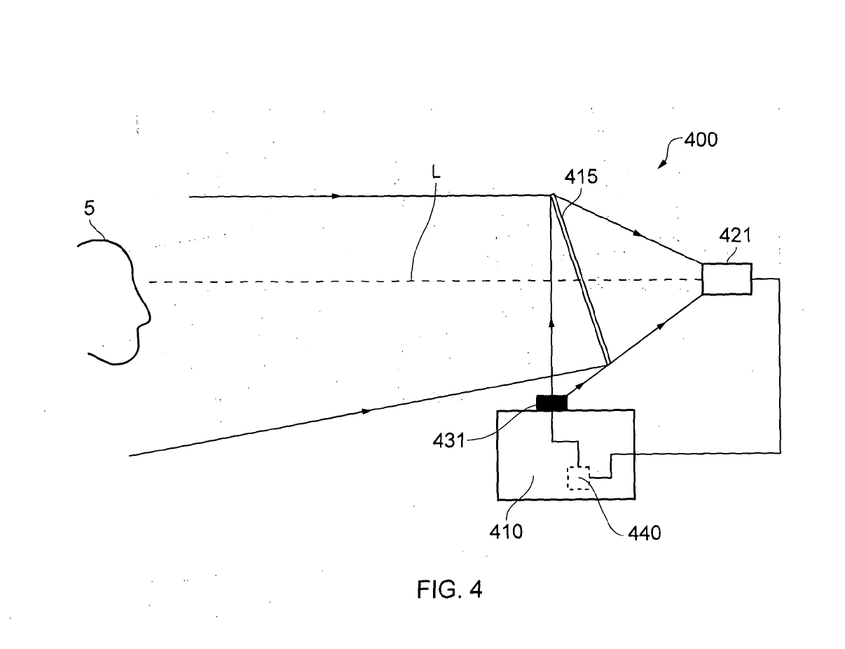

FIG. 4 shows apparatus 400 according to a further embodiment of the invention. Like features of the embodiment of FIG. 4 to those of the embodiment of FIG. 3 are provided with like reference signs prefixed numeral 4 instead of numeral 3.

The embodiment of FIG. 4 is similar to that of FIG. 3 in that a camera 421 is provided in a direct line of sight of a presenter 5. The camera 421 is arranged to capture an image of the presenter 5 through a reflector member 415 along a direct line of sight L. A projector module 431 is provided in a housing 410 and is arranged to project onto the reflector member 415 an image for viewing by the presenter 5.

A controller 440 is arranged to receive an image output of camera 421 and to undertake processing of images output by the camera 421. The controller 440 is configured to detect movement of eyes of the presenter by reference to the image output by the camera 421.

In the embodiment of FIG. 4 the controller 440 is operable to control the projector module 431 to project stationary text onto the reflector member 415 for viewing by the presenter 5. The controller 440 is configured to monitor movement of eyes of the presenter 5. When the controller 440 detects that the eyes of the presenter 5 are looking directly at a last word of a prescribed line of text displayed to the presenter 5 by the projector module 431 (such as a penultimate line) the controller 440 is configured to scroll the text (for example in an upwards or downwards direction) to show further text to the presenter 5. Thus the presenter is able to control operation of the apparatus to display text at a required moment in time.

Embodiments of the invention have the advantage that provision of prompting text to a presenter may be automated.

In some alternative embodiments, text may be scrolled or otherwise changed responsive to detection by the controller 440 that a presenter's eyes have completed a prescribed number of scans of the reflector member in a horizontal direction.

In some embodiments the controller 440 is operable to scroll text substantially constantly and to allow a presenter 5 to control a scroll rate of text responsive to eye movement.

In some embodiments the controller 440 is configured to receive commands from a presenter 5 by detecting one or more gestures made by a presenter 5. For example, the controller 440 may be configured to detect a particular head movement, hand or other body movement. The controller 440 may be configured to freeze an image presented to the presenter 5, such as text, a graphic or any other suitable image. In other words, the controller 440 may be arranged not allow the image to change responsive to eye movement until a further signal is detected by the controller 440.

Other arrangements are also useful.

It is to be understood that reference to a camera module includes reference to any device operable to obtain an image. A module may include means for effecting manipulation of other physical control of the device, such as one or more actuators for effecting pan, tilt, and/or zoom of the device where a module is provided with that capability.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. Apparatus comprising:
at least one camera device;
at least one image projection module; and
a display,
the image projection module being arranged to project an image onto the display for viewing by a user, the at least one camera device being arranged to generate an image of a user, the display being provided in an optical path from a user to the at least one camera device,
wherein the apparatus is operable to control a displayed image responsive to detection of one or more features in one or more images captured by the at least one camera device.

2. Apparatus as claimed in claim 1 wherein the at least one camera device is arranged to capture light transmitted through the display thereby to generate an image of a user.

3. Apparatus as claimed in claim 1 wherein the at least one camera device is arranged to capture light scattered by the display thereby to generate an image of a user.

4-7. (canceled)

8. Apparatus as claimed in claim 1 operable to control the displayed image responsive to detection of one or more objects identified in one or more images generated by the at least one camera device.

9. Apparatus as claimed in claim 1 operable to control the displayed image responsive to detection of a prescribed sequence of movements of one or more objects or part of an object in a plurality of images generated by the at least one camera device.

10. Apparatus as claimed in 8 wherein the object comprises at least a portion of a face of a person, the apparatus being operable to control the displayed image responsive to recognition of at least a portion of a face.

11-12. (canceled)

13. Apparatus as claimed in claim 8 operable to display information responsive to recognition of one or more objects.

14. (canceled)

15. Apparatus as claimed in claim 12 wherein the information corresponds to an identifier of one or more objects.

16. Apparatus as claimed in claim 9 wherein the apparatus is operable to control the displayed image responsive to recognition of a movement of a person, wherein the movement corresponds to movement of one selected from amongst an eye, a head, a hand, a leg and a foot.

17-21. (canceled)

22. Apparatus as claimed in claim 1 operable to control the displayed image whereby text or graphic content of a displayed image is changed, for example whereby text of graphic content of a displayed image is scrolled.

24. (canceled)

25. Apparatus as claimed in claim 1 operable to inhibit one or more functions of the apparatus responsive to detection of one or more features of one or more images captured by the at least one camera device.

26. (canceled)

27. Apparatus as claimed in claim 1 operable to provide to a remote user an image captured by the image capture device.

28. Apparatus as claimed in claim 1 operable to provide information to a remote user responsive to an image captured by the image capture device.

29-30. (canceled)

31. Apparatus as claimed in claim 27 operable to provide a captured image to a remote user only if the apparatus determines that the one or more features identified in an image correspond to a prescribed one or more features.

32. (canceled)

33. Apparatus as claimed in claim 1 comprising a plurality of image capture modules, a first module being operable to capture an image of a face of a person, a second module being operable to capture an image of an eye of a person, an image of any eye of a person captured by the second module having a higher resolution than a corresponding image of an eye of a person captured by the first module, wherein the apparatus is operable to control the second image capture module responsive to an image captured by the first image capture module.

34. (canceled)

35. Apparatus as claimed in claim 1 operable to perform a further one or more actions responsive to detection of one or more features of one or more images captured by the at least one camera device, the apparatus being operable to provide an output signal to an external apparatus or module responsive to detection of the one or more features, the apparatus being operable to provide an output signal to control one selected from amongst an access portal and a dispenser wherein the dispenser is operable to.

36-39. (canceled)

40. A prompting system for displaying text to a presenter comprising apparatus as claimed in claim 1.

41. A method comprising:
obtaining an image of a user by means of at least one camera device;
projecting by means of an image projection module an image onto a display for viewing by a user,
whereby the display is provided in an optical path from a user to the at least one camera device,
the method further comprising detecting one or more features of one or more images captured by the at least one camera device and controlling a displayed image responsive to detection of one or more features in one or more images captured by the at least one camera device.

42. Apparatus comprising:
a plurality of image processing modules, each image processing module being one selected from amongst an image capture module and an image projection module, the apparatus comprising at least one image capture module and at least one image projection module; and
a reflector member,
the image projection module being arranged to project an image onto the reflector member for viewing by a user, the image capture module being arranged to capture an image of the user via the reflector member,
at least one of the image processing modules being arranged to receive operational data from a source external to the module.

43. (canceled)

44. Apparatus as claimed in claim 42 wherein one of the modules is a master module and another module is a slave module, the slave module being arranged to receive operational data from the master module such that when an operational parameter of the master module is changed a corresponding change is made to a corresponding operational parameter of the slave module.

45-48. (canceled)

49. Apparatus as claimed in claim 44 comprising a plurality of image capture modules, wherein one of the image capture modules is a master image capture module and another one of the image capture modules is a slave image capture module.

50. (canceled)

51. Apparatus as claimed claim 42 wherein the external source comprises one selected from amongst external data storage apparatus and remote control apparatus.

52-55. (canceled)

56. Apparatus as claimed in claim 42 wherein the operational data comprises a value of at least one selected from amongst a colour setting, a white balance setting, an iris setting, a focus setting, a zoom setting, a pan setting and a tilt setting.

57-65. (canceled)
